(19) United States
(12) Patent Application Publication
(10) Pub. No.: US 2007/0141352 A1
(43) Pub. Date: Jun. 21, 2007

(54) Cross-directional elastic films with machine direction stiffness

(76) Inventors: Patricia Hwang Calhoun, Alpharetta, GA (US); Chiehlung Jay Hsu, Alpharetta, GA (US); Janis Wilson Hughes, Alpharetta, GA (US); Tamara Lee Mace, Doraville, GA (US); Prasad S. Potnis, Dulluth, GA (US); Glynis Allicia Walton, Roswell, GA (US); Gregory K. Hall, Menasha, WI (US)

Correspondence Address: Mark D. Swanson;Pauley Petersen & Erickson, Suite 365, 2800 West Higgins Road, Hoffman Estates, IL, 60195, US

(21) Appl. No.: 11/300,766

(22) Filed: Dec. 15, 2005

(51) Int. Cl. B32B 27/40; B32B 27/36; B32B 27/20; B32B 27/32

(52) U.S. Cl. 428/411.1; 428/500; 428/423.1; 428/523; 428/480; 428/910; 156/229

(57) ABSTRACT

A multilayer film including an elastomeric polymeric core layer and a polymeric skin layer on each side of the core layer. The polymeric skin layers are not elastomeric and the multilayer film is elastic in the cross-direction. The multilayered film is elastic in the cross-direction, has a non-tacky surface feel, and has machine-direction stiffness.

### BACKGROUND OF THE INVENTION

This invention is directed to films that are elastic in the cross-direction (CD) and stiff in the machine-direction (MD), and methods of making the films.

Many personal care products contain elastic laminate components in such areas as leg gaskets, waistbands, and side panels. These elastic laminates provide a variety of functionalities including one-size-fits-all capability, conformance of the product on the user, sustained fit over time, leakage protection, and improved absorbency, for example.

Films and film laminates with good cross-directional stretch properties are desirable for elastic components in personal care products. However, typically films that are elastic in the cross-direction are also elastic in the machine-direction. Such elastic films often present challenges or difficulties during processing and personal care product manufacturing.

Current diaper waistbands are often made using a machine-direction (MD) stretchable laminate material. Because the stretch is in the MD of the material, the laminate is typically cut and rotated when applied to the diaper. Efforts to incorporate elastomeric materials, such as SIS/SBS (styrene-isoprene-styrene/styrene-butadiene-styrene) styrenic block copolymer elastomer film (having both MD and CD stretch), without the need for rotation, have generally not been as successful as desired. For example, application of such elastomeric materials has been attempted using a “slip-cut” applicator, which “slips” the material over a vacuum roll and cuts the material as needed. After the material is cut the material ceases to be held by the vacuum roll and is attached to the outer cover of the diaper. The elasticity in the machine direction generally caused the elastomer film laminate material to snap back and fly off of or “fold over” on the vacuum roll when cut. This condition was caused or worsened by the rubbery or sticky surface texture of the elastomer film. The elastomeric film was too rubbery, i.e., had too high a coefficient of friction, for effective transfer using the vacuum roll.

There is a need for a film with cross-directional elasticity that allows for manufacturing personal care products. There is a need for an elastic film that has less machine-direction elasticity while maintaining desirable cross-direction elasticity. There is also a need for a film having the desired cross-directional stretch while having a non-rubbery surface.

### SUMMARY OF THE INVENTION

A general object of the invention is to provide a film having desirable cross-directional stretch properties and machine-direction stiffness.

A more specific objective of the invention is to overcome one or more of the problems described above.

The general object of the invention can be attained, at least in part, through a multilayer film including an elastomeric polymeric core layer and a polymeric skin layer on at least one side of the core layer. The polymeric skin layer is not elastomeric and the multilayer film is elastic in the cross-direction.

The multilayered films of this invention have good cross-directional stretch properties, e.g., are elastic in the cross-direction, have a non-tacky surface feel, and have machine-direction stiffness. These properties, particularly the machine direction stiffness, allow for ease of applying the material to, for example, the waistband of diapers without the need for rotating the material. The multilayered films of this invention are thus useful and desirable for forming elastomeric parts of disposable personal care products. The multilayered films of this invention can also be filled to provide a breathable multilayer film.

The multilayered films of this invention include an elastomeric core layer that can be made by extruding any elastomeric polymer, including, without limitation, styrenic block copolymers, thermoplastic polyurethanes, and metallocene polyolefins. Such elastomeric polymers provide a film that stretches in both directions and is relatively tacky and/or rubbery. As discussed above, the tacky and/or rubbery properties of such films can cause difficulties during product converting and manufacturing. To improve the processing characteristics, one or more skin layers of various thicknesses are applied to one or more sides of the elastomeric core layer. The skin layers are formed from stiffer polyolefins such as polypropylene and/or polyethylene. The skin layers cover the rubbery surface feel of the core layer and impart stiffness.

The multilayered films of this invention are coextruded and desirably stretched in the machine direction to orient the skin layer. The orientation of the skin layers results in more stiffness in the machine direction than the cross direction. The machine-direction stiffness can be controlled by the MD stretch ratio, the amount of skin layer, and the skin layer composition(s). The skin layers can be oriented in the machine direction using a machine direction orienter or groove rolls, and can be oriented in the cross-direction by groove rolls and/or a tenter frame, as are known to those skilled in the art. The cross-directional stretch properties of the multilayered film can be controlled by the amount of the skin layer, the skin layer composition(s), and, if used, the cross-direction orienting of the groove roll or tenter frame. The orientation of the multilayered film of this invention imparts MD stiffness and CD elasticity without the need for cracking or rupturing the skin layers. The skin layers of one embodiment of this invention are extendible and not brittle, and do not substantially crack when stretched during CD orientation and/or use.

The multilayered film of this invention provides a low-cost option for waistband, stretch ear, or other stretch component in personal care products.

### BRIEF DESCRIPTION OF THE DRAWINGS

These and other objects and features of this invention will be better understood from the following detailed description taken in conjunction with the drawings, wherein:

FIG. 1 is a sectional view of one embodiment of the invention, which is a two-layer film.

FIG. 2 is a sectional view of another embodiment of the invention, which is a three-layer breathable film

FIG. 3 is a sectional view of a laminate including a breathable film of the invention.

FIG. 4 is a schematic diagram of an integrated process for making a breathable film and laminate of the invention.

FIGS. 5-8 are tables reporting and summarizing the Examples disclosed herein.

### DEFINITIONS

Within the context of this specification, each term or phrase below will include the following meaning or meanings.

The terms “machine direction” or “MD” are to be understood as referring to the length of a film in the direction in which it is produced. The terms “cross machine direction,” “cross directional,” “cross-direction”, or “CD” refer to the width of film, i.e. a direction generally perpendicular to the MD.

“Elastic” and “elastomeric” refer to a fiber, film or fabric which upon application of a biasing force, is stretchable by at least 50% to a stretched, biased length which is at least 50% greater than, its relaxed, unstretched length, and which will recover at least 50 percent of its elongation upon release of the stretching, biasing force.

“Recover” refers to a relaxation of a stretched material upon removal of a biasing force following stretching of the material by application of the biasing force. For example, if a material having a relaxed, unbiased length of one (1) inch was elongated 50 percent by stretching to a length of one and one half (1.5) inches the material would have a stretched length that is 50% greater than its relaxed length. If this exemplary stretched material contracted, that is recovered to a length of one and one tenth (1.1) inches after release of the biasing and stretching force, the material would have recovered 80 percent (0.4 inch) of its elongation.

As used herein, the term “elastomer” shall refer to a polymer which is elastomeric.

As used herein, the term “inelastic” or “nonelastic” refers to any material which does not fall within the definition of “elastic” above.

The term “extendible” is used herein to mean a material which upon application of a stretching force, can be extended in a particular direction, to a stretched dimension (e.g., width) which is at least 25% greater than an original, unstretched dimension without rupturing or substantial cracking. When the stretching force is removed after a one-minute holding period, the material does not retract, or retracts by not more than 30% of the difference between the stretched dimension and the original dimension. Extendible materials are different from elastic materials, the latter tending to retract most of the way to their original dimension when a stretching force is released. The stretching force can be any force sufficient to extend the material to between 125% of its original dimension, and its maximum stretched dimension in the selected direction (e.g. the cross-direction) without rupturing it.

As used herein the term “extensible” means elongatable in at least one direction, but not necessarily recoverable.

“Stretch” or “stretching” refers to the act of applying an extending force to a material that may or may not undergo retraction.

“Polymer” and “polymeric” includes homopolymers, copolymers, such as for example, block, graft, random and alternating copolymers, terpolymers, etc., and blends and modifications thereof. The term “polymer” also includes all possible geometric configurations of the molecule. These configurations include, but are not limited to, isotactic, syndiotactic and random symmetries.

“Block copolymer” is a polymer in which dissimilar polymer segments, each including a string of similar monomer units, are connected by covalent bonds. For instance, a SBS block copolymer includes a string or segment of repeating styrene units, followed by a string or segment of repeating butadiene units, followed by a second string or segment of repeating styrene units.

“Blend” refers to a mixture of two or more polymers.

As used herein, the term “thermoplastic” shall refer to a polymer which is capable of being melt processed.

“Nonwoven fabric or web” means a web having a structure of individual fibers or threads which are interlaid, but not in an identifiable manner as in a knitted or woven fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

“Spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (from a sample of at least 10) larger than 7 microns, more particularly, between about 10 and 20 microns.

“Meltblown fibers” means fibers formed by extruding a molten thermoplastic material through a plurality of fine, usually circular, die capillaries as molten threads or filaments into converging high velocity, usually hot, gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are usually tacky when deposited onto a collecting surface.

“Personal care product” includes diapers, training pants, absorbent underpants, adult incontinence products, and feminine hygiene products.

As used herein the term “sheet” or “sheet material” refers to woven materials, nonwoven webs, polymeric films, polymeric scrim-like materials, and polymeric foam sheeting.

As used herein the term “laminate” refers to a composite structure of two or more sheet material layers that have been adhered through a bonding step, such as through adhesive bonding, thermal bonding, point bonding, pressure bonding, extrusion coating or ultrasonic bonding.

“Filler” refers to particulates and/or other forms of materials which can be added to a film polymer extrusion material which will not chemically interfere with or adversely affect the extruded film and further which are capable of being dispersed throughout the film. Generally the fillers will be in particulate form with average particle sizes in the range of about 0.1 to about 10 microns, desirably from about 0.1 to about 4 microns. As used herein, the term “particle size” describes the largest dimension or length of the filler particle.

As used herein, the term “breathable” refers to a material which is permeable to water vapor. The water vapor transmission rate (WVTR) or moisture vapor transfer rate (MVTR) is measured in grams per square meter per 24 hours, and shall be considered equivalent indicators of breathability. The term “breathable” desirably refers to a material which is permeable to water vapor having a minimum WVTR (water vapor transmission rate) of desirably about 100 g/m²/24 hours. Even more desirably, such material demonstrates breathability greater than about 300 g/m²/24 hours. Still even more desirably, such material demonstrates breathability greater than about 1000 g/m²/24 hours.

A suitable technique for determining the WVTR (water vapor transmission rate) value of a film or laminate material of the invention is the test procedure standardized by INDA (Association of the Nonwoven Fabrics Industry), number IST-70.4-99, entitled “STANDARD TEST METHOD FOR WATER VAPOR TRANSMISSION RATE THROUGH NONWOVEN AND PLASTIC FILM USING A GUARD FILM AND VAPOR PRESSURE SENSOR” which is incorporated by reference herein. The INDA procedure provides for the determination of WVTR, the permeance of the film to water vapor and, for homogeneous materials, water vapor permeability coefficient.

The INDA test method is well known and will not be set forth in detail herein. However, the test procedure is summarized as follows. A dry chamber is separated from a wet chamber of known temperature and humidity by a permanent guard film and the sample material to be tested. The purpose of the guard film is to define a definite air gap and to quiet or still the air in the air gap while the air gap is characterized. The dry chamber, guard film, and the wet chamber make up a diffusion cell in which the test film is sealed. The sample holder is known as the Permatran-W Model 100K manufactured by Mocon, Inc., Minneapolis, Minn. A first test is made of the WVTR of the guard film and the air gap between an evaporator assembly that generates 100% relative humidity. Water vapor diffuses through the air gap and the guard film and then mixes with a dry gas flow which is proportional to water vapor concentration. The electrical signal is routed to a computer for processing. The computer calculates the transmission rate of the air gap and the guard film and stores the value for further use.

The transmission rate of the guard film and air gap is stored in the computer as CalC. The sample material is then sealed in the test cell. Again, water vapor diffuses through the air gap to the guard film and the test material and then mixes with a dry gas flow that sweeps the test material. Also, again, this mixture is carried to the vapor sensor. This information is used to calculate the transmission rate at which moisture is transmitted through the test material according to the equation:
TR⁻¹_{test material}=TR⁻¹_{test material, guardfilm, airgap}−TR⁻¹_{guardfilm, airgap}

Calculations:

WVTR: The calculation of the WVTR uses the formula:
WVTR=Fpₛₐₜ(T)RH/(APₛₐₜ(T)(1−RH))
Where “F” is the flow of water vapor in cc/min., “pₛₐₜ(T)” is the density of water in saturated air at temperature “T”, “RH” is the relative humidity at specified locations in the cell, “A” is the cross sectional area of the cell, and “pₛₐₜ(T)” is the saturation vapor pressure of water vapor at temperature T.

As used herein and in the claims, the term “comprising” is inclusive or open-ended and does not exclude additional unrecited elements, compositional components, or method steps. Accordingly, such terms are intended to be synonymous with the words “has”, “have”, “having”, “includes”, “including”, and any derivatives of these words.

As used herein the term “percent stretch” refers to the ratio determined by measuring the increase in the stretched dimension and dividing that value by the original dimension, i.e., (increase in stretched dimension/original dimension)×100.

As used herein the term “set” refers to retained elongation in a material sample following the elongation and recovery, i.e. after the material has been stretched and allowed to relax during a cycle test.

As used herein the term “percent set” is the measure of the amount of the material stretched from its original length after being cycled (the immediate deformation following the cycle test). The percent set is where the retraction curve of a cycle crosses the elongation axis. The remaining strain after the removal of the applied stress is measured as the percent set.

The “load loss” value is determined by first elongating a sample to a defined elongation in a particular direction (such as the CD) of a given percentage and then allowing the sample to retract to an amount where the amount of resistance is zero. The cycle is repeated a second time and the load loss is calculated at a given elongation. For the purposes of this application, the load loss was calculated as follows:

cycle 1 extension tension (at “x” % elongation)- cycle 2 retraction tension (at “x” % elongation)×100 cycle 1 extension tension (at “x” % elongation)

The actual test method for determining load loss values is described below.

Unless otherwise indicated, percentages of components in formulations are by weight.

### DESCRIPTION OF PREFERRED EMBODIMENTS

The present invention intends to overcome the above problems of processing elastic films for manufacturing personal care products. The problems are addressed in a first embodiment of the invention by a multilayered film including an elastomeric polymeric core layer and at least one polymeric skin layer on a side of the core layer. The polymeric skin layer(s) is/are not elastomeric and provide(s) ease of processing. The multilayer film is elastic in a cross-direction and stiff in a machine direction.

The multilayered films of the current invention are desirably extruded using either a cast or blown film process, or extrusion coating type of manufacturing process. In one embodiment of this invention, an extendible, inelastic skin layer is coextruded on each side of the elastomeric core layer, thereby sandwiching the core layer. It has been found that each of the above multilayered film structures allow for improved processing functionality.

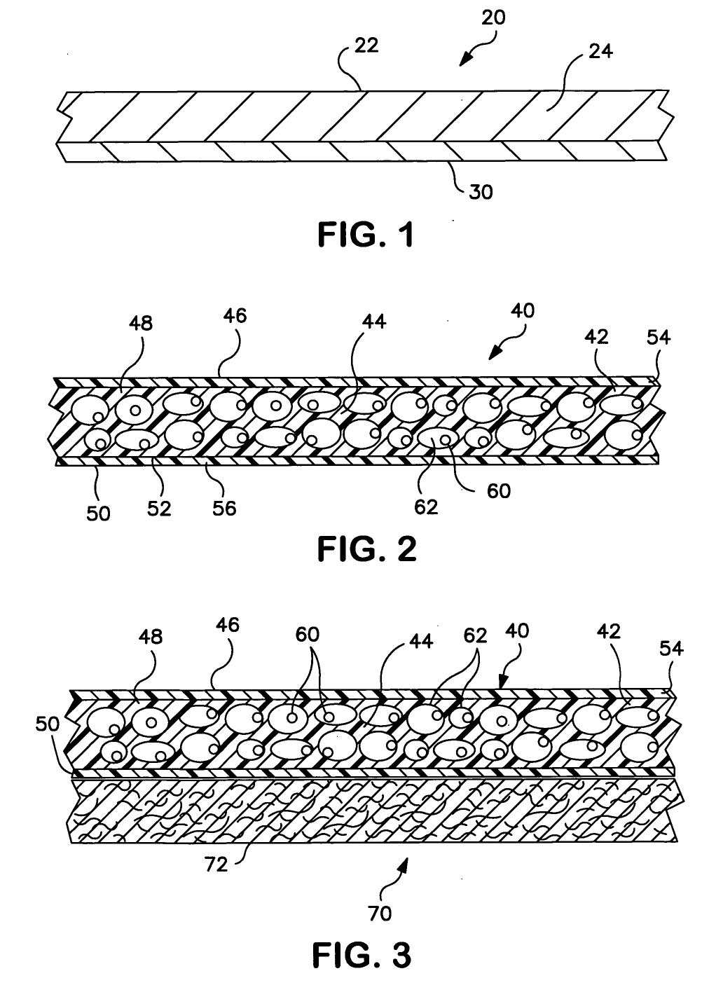

FIG. 1 illustrates a cross sectional view of one embodiment of a multilayered film of this invention. In this particular embodiment, the multilayered film 20 includes an elastomeric core layer 22 having an elastomeric polymeric component 24. A skin (or outer) layer 30 is positioned on one surface of the core layer 22. While one skin layer is illustrated in FIG. 1 on only one side of the core layer 22, it should be appreciated by those skilled in the art following the teachings herein provided that the multilayered film may include two opposing skin layers, or more than one skin layer on at least one surface of the core layer 22.

FIG. 2 illustrates a multilayered film 40 according to another embodiment of this invention. The multilayered film 40 includes an elastomeric core layer 42 having an elastomeric polymeric component 44. A polymeric first skin layer 46 is disposed on a first side 48 of the core layer 42. A polymeric second skin layer 50 is disposed on a second side 52 of the core layer 42 that is opposite the first side 48. Each of the first skin layer 46 and the second skin layer 50 have a polymeric component 54 and 56, respectively, which is not elastomeric. As will be appreciated, the polymeric components 54 and 56 can be the same, similar, or different from each other.

The multilayered film 40 is a filled breathable film. The core layer 42 includes a plurality of filler particles 60 in pores 62 dispersed throughout elastomeric polymeric component 44. The pores 62 are formed as the film 40 is stretched in a machine direction orienter or other stretching device, such as described further below. The filler desirably creates filled regions within the extruded film core layer, which can be stretched to form pores at a polymer/filler interface without negatively impacting the elastic recovery of the elastic polymer component. The pores or voids are somewhat defined and separated by thin polymer membranes which permit molecular diffusion of water vapor through the film. This diffusion is what causes the film to have water vapor breathability. In one embodiment of this invention, the multilayer film has a water vapor transmission rate of at least about 300 grams/m²-24 hours, and more desirably at least about 1000 grams/m²−24 hours, and preferably about 1000 grams/m²−24 hours to about 5000 grams/m²−24 hours. While the film 40 is shown with filler only in the core layer 40, filler particles can be disposed in one or more of the skin layers of the invention as well to further improve or impart breathability.

FIG. 3 shows a cross sectional view of a laminate 70 including the multilayered film 40 of FIG. 2. A substrate layer 72, which can be a fibrous nonwoven web, for instance, a spunbond or meltblown web is laminated by thermal bonding, adhesive bonding, ultrasonic bonding or the like, to the film 40.

Various thermoplastic elastomers are contemplated for use in this invention as the core elastomeric portion. In one embodiment of this invention, the core layer includes a polymer selected from styrenic block copolymers, thermoplastic polyurethanes, single-site catalyzed polyolefins, thermoplastic polyester elastomers, or combinations thereof.

Specific examples of useful styrenic block copolymers include hydrogenated polyisoprene polymers such as styrene-ethylenepropylene-styrene (SEPS), styrene-ethylenepropylene-styrene-ethylenepropylene (SEPSEP), hydrogenated polybutadiene polymers such as styrene-ethylenebutylene-styrene (SEBS), styrene-ethylenebutylene-styrene-ethylenebutylene (SEBSEB), styrene-butadiene-styrene (SBS), styrene-isoprene-styrene (SIS), and hydrogenated poly-isoprene/butadiene polymer such as styrene-ethylene-ethylenepropylene-styrene (SEEPS). Polymer block configurations such as diblock, triblock, multiblock, star and radial are also contemplated in this invention. In some instances, higher molecular weight block copolymers may be desirable. Block copolymers are available from KRATON Polymers U.S. LLC of Houston, Tex. under the designations KRATON® G and D polymers, and Septon Company of America, Pasadena, Tex. Another potential supplier of such polymers includes Dynasol of Spain, and Dexco polymers of Houston, Tex. Blends of such polymers are contemplated for the core layer(s).

Such elastomeric polymers may be styrenic block copolymers, such as for example SEBS and SEB polymers available from KRATON Polymers. An example of such block copolymers includes SEBS polymers, such as KRATON® G 1657 (MI 22 g/10 min at 230° C., 5 kg).

Other suitable elastomeric polymers include single site catalyzed polyolefinic elastomers. Such single site catalyzed materials include metallocene catalyzed materials and constrained geometry polymers. In one embodiment of this invention, the elastomeric polymer is a single site metallocene catalyzed linear low density polyethylene (LLDPE), such as are available from Dow Chemical Company under the trade name AFFINITY®. Metallocene catalyzed polymers are described in U.S. Pat. No. 5,472,775 to Obijeski et al. and assigned to the Dow Chemical Company, the entire contents of which are incorporated herein by reference. The metallocene process generally uses a metallocene catalyst which is activated, i.e. ionized, by a co-catalyst. Examples of metallocene catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-flourenyl)zirconium dichloride, molybdocene dichloride, nickelocene, niobocene dichloride, ruthenocene, titanocene dichloride, zirconocene chloride hydride, zirconocene dichloride, among others. A more exhaustive list of such compounds is included in U.S. Pat. No. 5,374,696 to Rosen et al. and assigned to the Dow Chemical Company. Such compounds are also discussed in U.S. Pat. No. 5,064,802 to Stevens et al. and also assigned to Dow. However, numerous other metallocene, single-site and/or similar catalyst systems are known in the art; see for example, U.S. Pat. No. 5,539,124 to Etherton et al.; U.S. Pat. No. 5,554,775 to Krishnamurti et al.; U.S. Pat. No. 5,451,450 to Erderly et al. and The Encyclopedia of Chemical Technology, Kirk-Othemer, Fourth Edition, vol. 17, Olefinic Polymers, pp. 765-767 (John Wiley & Sons 1996); the entire content of the aforesaid patents being incorporated herein by reference.

In one embodiment of this invention, the core layer includes KRATON® G 1730 tetrablock (MI 13 g/10 min at 230° C., 5 kg). An example of another elastomer is Septon 2004 (MFR of 5 at 230° C., 2.26 kg, 27 MFR at 250° C., 5 kg) from Septon Company of America. In such embodiments, the filler is desirably calcium carbonate and is present in an amount of between about 50 and 80 percent and includes a carrier resin in the compound is present in an amount of between about 20 and 50 percent. These percentages are by weight. Desirably the compound is present in an amount with the polymer between about 50 and 75 percent. Such compounded resin may for example be a polyethylene, desirably a LLDPE such as for example DOWLEX™ 2517 LLDPE.

In one embodiment of this invention, it is desirable that the styrenic block copolymer be a SEPS polymer. The thermoplastic elastomers themselves may include processing aids and/or tackifiers associated with the elastomeric polymers. Other thermoplastic elastomers useful in the invention include olefinic-based elastomers such as EP rubber, ethyl, propyl, butyl terpolymers, block and copolymers thereof. It should be recognized, that when the elastomer component of the blended elastomeric composition is given, it may include neat base resins along with processing aids such as low molecular weight hydrocarbon materials such as waxes, amorphous polyolefins and/or tackifiers.

The skin layers of this invention are not elastomeric, but are desirable extendible in that they can be extended upon application of a stretching force without rupturing or substantial cracking (depending on the film composition, minor random cracks may be unavoidable and inconsequential). The skin layers of this invention are not brittle, and the extendibility of the skin layers is not the result of a plurality of cracks in the skin layers. In one embodiment of this invention, the skin layer includes a polyolefin. Examples of polyolefins useful for the skin layers of this invention include polypropylene, polyethylene, polybutylene, polyester, polystyrene, or combinations thereof. The multilayer film of this invention desirably includes about 2.5% to about 30% by weight of skin layer(s), and more desirably about 2.5% to about 15% by weight. For example, referring to FIG. 2, each of skin layers 46 and 50 can account for up to 7.5% (15% total) of the total weight of film 40.

The multilayer film of this invention is elastic in the cross-direction even though the skin layers are not elastomeric. In one embodiment of this invention, the multilayer film can be stretched by at least about 50% in the cross-direction. In another embodiment the multilayer film can be stretched by at least about 100% in the cross-direction, and retracts at least 50% upon releasing of the stretching force. The multilayer film, while elastic in the cross-direction, is stiff in the machine direction. By orienting the polymers of the skin layers, the elasticity of the multilayer film in the machine direction is reduced. In one embodiment of this invention, the multilayer film is stable in a machine-direction. As used herein, “stable” describes a film that provides a load of at least about 500 g at 10% MD extension. More preferably, the multilayer films of this invention provide a load of at least about 1000 g at 10% MD extension for a 3 inch wide sample. In another embodiment of this invention, the multilayer film is inelastic in the machine direction and elastic in the cross direction.

The skin layers of this invention are desirably less tacky than the elastomeric core layer, and more desirably non-tacky, thereby providing a more desirable film surface than the tacky and/or rubbery surface of the core elastomer. In one embodiment of this invention, the skin layer has a dynamic coefficient of friction of about 0.75 or less, more desirably about 0.5 or less, and preferably about 0.3 to 0.5.

The skin layers can desirably reduce or eliminate roll-blocking, and also desirably improve die life by reducing or eliminating die build-up. The skin layers can also improve the annealing of the elastomeric resin based film structure at higher temperatures, without sticking to the rolls of a machine direction orienter. As a result, such structure can improve the dimensional stability of the stretchable and breathable film. In one embodiment, the skin layers are comprised of filled polypropylene, or polypropylene copolymers.

It has been found that the multilayered film structures of this invention allow for improved processing functionality, particularly in forming personal care products such as diapers.

It should be recognized that each of the various layers may also include other materials. For example, in order to achieve breathability in an elastic core layer and/or skin layers, it has been necessary to include other components such as filler, and a carrier polymer for carrying the filler. Such layers may also include processing aids, stabilizers, antioxidants and coloring agents as well. The skin layer(s) may also include one or more anti-blocking components to reduce roll blocking.

Both organic and inorganic fillers are contemplated for use with the present invention, provided they do not interfere with the film forming process and/or subsequent laminating processes. Examples of fillers include calcium carbonate (CaCO₃), various clays, silica (SiO₂), alumina, barium sulfate, sodium carbonate, talc, magnesium sulfate, titanium dioxide, zeolites, aluminum sulfate, cellulose-type powders, diatomaceous earth, gypsum, magnesium sulfate, magnesium carbonate, barium carbonate, kaolin, mica, carbon, calcium oxide, magnesium oxide, aluminum hydroxide, pulp powder, wood powder, cellulose derivatives, polymeric particles, chitin and chitin derivatives.

The filler particles may optionally be coated with a fatty acid, such as stearic acid or behenic acid, and/or other material in order to facilitate the free flow of the particles (in bulk) and their ease of dispersion into the carrier polymer. One such filler is calcium carbonate sold under the brand SUPERCOAT, of Imerys of Roswell, Ga. Another is OMYACARB 2 SS T of Omya, Inc. North America of Proctor, Vt. The latter filler is coated with stearic acid. Desirably, the amount of filler in the product film core layer (final film formulation) is between about 40 and 70 weight percent. More desirably, the amount of filler in the product film core layer is between about 45 and 60 weight percent. The filler particles are preferably small, in order to maximize vapor transmission through the voids. Generally, the filler particles should have a mean particle diameter of about 0.1 to 7.0 microns, preferably about 0.5 to 7.0 microns, most preferably about 0.8 to 2.0 microns.

Examples of semi-crystalline carrier polymers useful in compounding with filler include, but are not limited to predominantly linear polyolefins (such as polypropylene and polyethylene) and copolymers thereof. Such carrier materials are available from numerous sources. Specific examples of such semi-crystalline polymers include ExxonMobil 3155 and Dow Chemical polyethylenes such as DOWLEX™ 2517 (25 MI, 0.917 g/cc). In some instances, higher density polymers may be useful as well. Additional resins include Escorene LL 5100, having a MI of 20 and a density of 0.925 and Escorene LL 6201, having a MI of 50 and a density of 0.926 from ExxonMobil.

In an alternative embodiment, polypropylene carrier resins with lower densities such as at about 0.89 g/cc, would also be useful, especially those with a 10 g/10 min MFR, but desirably a 20 MFR or greater (conditions of 230° C., 2.16 kg). Polypropylene-based resins having a density of between 0.89 g/cc and 0.90 g/cc would be useful, such as homopolymers and random copolymers such as ExxonMobil PP3155 (36 MFR).

It is desirable that the melt index of the semi-crystalline polymer (for polyethylene-based polymers) be greater than about 5 g/10 min, as measured by ASTM D1238 (2.16 kg, 190° C.). More desirably, the melt index of the semi-crystalline polymer is greater than about 10 g/10 min. Even more desirably, the melt index is greater than about 20 g/10 min. Desirably, the semi-crystalline carrier polymer has a density of greater than about 0.910 g/cc, but even more desirably greater than about 0.915 g/cc for polyethylene-based polymers. Even more desirably, the density is about 0.917 g/cc. In another alternative embodiment, the density is greater than 0.917 g/cc. In still another alternative embodiment, the density is between about 0.917 g/cc and 0.923 g/cc. In still another alternative embodiment, the semi-crystalline carrier polymer has a density between about 0.917 and 0.960 g/cc. In yet another alternative embodiment, the semi-crystalline polymer has a density between about 0.923 g/cc and 0.960 g/cc. It is also desirable that the film core layer contains between about 10 and 25 weight percent semi-crystalline polymer.

In addition, the breathable filled film layer(s) may optionally include one or more stabilizers or processing aids. For instance, the filled-film may include an anti-oxidant such as, for example, a hindered phenol stabilizer. Commercially available anti-oxidants include, but are not limited to, IRGANOX E 17 (a-tocopherol) and IRGANOX 1076 (octodecyl 3,5-di-tert-butyl-4-hydroxyhydrocinnamate) which are available from Ciba Specialty Chemicals of Tarrytown, N.Y. In addition, other stabilizers or additives which are compatible with the film forming process, stretching and any subsequent lamination steps, may also be employed with the present invention. For example, additional additives may be added to impart desired characteristics to the film such as, for example, melt stabilizers, processing stabilizers, heat stabilizers, light stabilizers, heat aging stabilizers and other additives known to those skilled in the art. Generally, phosphite stabilizers (i.e. IRGAFOS 168 available from Ciba Specialty Chemicals of Tarrytown, N.Y. and DOVERPHOS available from Dover Chemical Corp. of Dover, Ohio) are good melt stabilizers whereas hindered amine stabilizers (i.e. CHIMASSORB 944 and 119 available from Ciba Specialty Chemicals of Tarrytown, N.Y.) are good heat and light stabilizers. Packages of one or more of the above stabilizers are commercially available such as B900 available from Ciba Specialty Chemicals. Desirably about 100 to 2000 ppm of the stabilizers are added to the base polymer(s) prior to extrusion (Parts per million is in reference to the entire weight of the filled-film).

Desirably in one embodiment, a concentrate of “filled polymer” (carrier resin and filler) is made for the core layer(s), with the filler and the semi-crystalline carrier polyolefin in the range of between about 20-80%, desirably between about 60-85% by weight filler, but more desirably between about 70-85% by weight filler. It is also desirable to reduce the amount of the semi-crystalline polymer in the final composition so as to have the least impact on the elastic performance of the elastomeric polymer phase of the core layer(s). The high viscosity elastic polymer (or polymer blend) is blended with the filled polymer concentrate resin prior to introduction into the film screw extruder in a blending station as a “letdown” resin. The concentration of the block polymer is then generally determined by the desired filler level in the final composition. The level of filler will affect breathability as well as elastic properties of the film core layer(s) and ultimate multiple layered film. In one embodiment, it is desirable for the filler to be present in the filled polymer in an amount of greater than 80 weight percent, such that the film demonstrates the desired properties which are described below.

As an example, the filler may be present in a film core layer(s) of between about 25-65 weight percent, the elastomer (or blend) may be present in a range between about 15-60 weight percent, and the semi-crystalline polymer may be present in a range of between about 5-30 weight percent.

The skin layers of the multilayered film are desirably formed from a coextrusion process with the core layer, and processed along with the core layer in the stretching and other post formation processes. The skin layer(s) of such a multilayered breathable and elastic film desirably do not hinder the breathability attributes of the core layer. Such skin layers desirably also provide additional functionality to the core layer features. As discussed above, in one embodiment, the skin layer(s) includes filler, such as calcium carbonate, along with, for example, a polyethylene base resin in order to enhance the breathability attributes of such multilayered film, reduce the blocking of such film even further, and/or also to provide enhanced bonding capability of such film to other sheet materials with the use of adhesives. If such filler is present, it is desirably present in an amount of between about 10 and 50 weight percent of the skin layer(s).

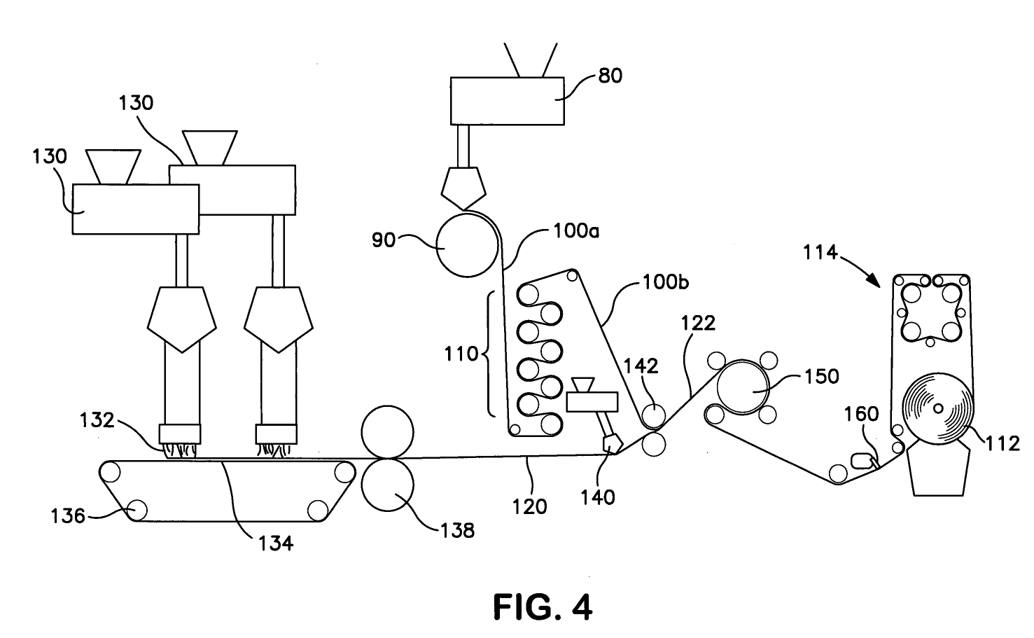

A process for forming a breathable multilayered elastic film of this invention is shown in FIG. 4. Compounded polymers and filler are placed in an extruder 80 apparatus and then cast or blown into a film. For simplicity, a single extruder 80 is shown; however, more than one extruder is desirably used for extruding a multilayered film of this invention, e.g., an extruder for the core layer and one or more extruders for the skin layer(s). For example, three extruders can desirably be used to extrude three layers side by side through a film die. A multilayer precursor film 100a is extruded (e.g., at a temperature range of between about 380-440° F.) onto for instance, a casting roll 90, which may be smooth or patterned. The multiple layers are coextruded together onto the casting roll 90. The term “precursor” film shall be used to refer to the film prior to being made breathable, such as by being run through a machine direction orienter. The flow out of the extruder die is immediately cooled on the casting roll 90. A vacuum box (not shown) may be situated adjacent the casting roll in order to create a vacuum along the surface of the roll to help maintain the precursor film 100a lying close to the surface of the roll. Additionally, air knives or electrostatic pinners (not shown) may assist in forcing the precursor film 100a to the casting roll surface as it moves around the spinning roll. An air knife is a device known in the art which focuses a stream of air at a very high flow rate to the edges of the extruded polymer material. The precursor film 100a (prior to run through the MDO) is desirably about 20 to 100 microns in thickness, and has an overall basis weight of about 30 gsm to 100 gsm. In one embodiment the basis weight is preferably about 50 to 75 gsm. Following stretching in a stretching apparatus 110, the basis weight of the film is desirably about 10 to 60 gsm, and more desirably about 15 to 60 gsm.

As previously stated, the precursor film 100a is subjected to further processing to make it breathable. Therefore, from the extrusion apparatus 80, and casting roll 90, the precursor film 100a is directed to a film stretching unit 110, such as a machine direction orienter or “MDO” which is a commercially available device from vendors such as the Marshall and Williams Company of Providence, R.I. This apparatus may have a plurality of stretching rollers (such as, for example, from 5 to 8) which progressively stretch and thin the film in the machine direction, which is the direction of travel of the film through the process as shown in FIG. 4. While the MDO 110 is illustrated with eight rolls, it should be understood that the number of rolls may be higher or lower, depending on the level of stretch that is desired and the degrees of stretching between each roll. The film can be stretched in either single or multiple discrete stretching operations. It should be noted that some of the rolls in an MDO apparatus may not be operating at progressively higher speeds.

Desirably, the precursor film 100a (unstretched filled multilayered film) will be oriented (stretched) from about 2 to about 5 times its original length, imparting a final stretch of between 1.5 to about 4 times of the original film length after the film is allowed to relax at the winder. In an alternative embodiment, the film may be CD stretched, desirably in addition to stretching using an MDO, through intermeshing grooved rolls such as those described in U.S. Pat. No. 4,153,751 to Schwarz, or using a tenter frame, as is known to those skilled in the art.

Optionally, some of the rolls of the MDO 110 may act as preheat rolls. If present, these first few rolls heat the film above room temperature (125° F.). The progressively faster speeds of adjacent rolls in the MDO act to stretch the filled precursor film 100a. The rate at which the stretch rolls rotate determines the amount of stretch in the film and final film weight. Microvoids, such as shown in FIG. 2, are formed during this stretching to render the film (i.e., core layer and/or skin layers) microporous and subsequently breathable. After stretching, the stretched film 100b may be allowed to slightly retract and/or be further heated or annealed by one or more heated rolls 114, such as by heated anneal rolls. These rolls are typically heated to about 150-220° F. to anneal the film. The film may then be cooled. After exiting the MDO film stretching unit, the then breathable multilayer film 100b (which includes a core and at least one skin layer) may be wound on a winder 112 for storage or proceed for further processing.

If desired, the produced breathable multilayered film 100b may be attached to one or more layers 120, such as nonwoven layers, to form a multilayer film laminate 122. In one embodiment of this invention, in order to achieve a laminate with improved body conformance, the fibrous layer is itself desirably an extensible fabric and even more desirably an elastic fabric. For example, tensioning a nonwoven fabric in the MD causes the fabric to “neck” or narrow in the CD and give the necked fabric CD extensibility. Examples of additional suitable extensible and/or elastic fabrics include, but are not limited to, those described in U.S. Pat. No. 4,443,513 to Meitner et al.; 5,116,662 to Morman et al.; 4,965,122 to Morman et al.; 5,336,545 to Morman et al.; 4,720,415 to Vander Wielen et al.; 4,789,699 to Kieffer et al.; 5,332,613 to Taylor et al.; 5,288,791 to Collier et al.; 4,663,220 to Wisneski et al.; and 5,540,976 to Shawver et al. The entire content of the aforesaid patents are incorporated herein by reference. Such necked nonwoven material may be bonded to the film of the present invention. In an alternative embodiment, a slit and necked nonwoven material may be bonded to the film of the present invention. In still a further alternative embodiment, a spunbond support layer may be stretched in grooved rolls from between 1.5 to 3× in the CD and then necked to the original width or to match the width of the film prior to being adhesively laminated to the film.

Nonwoven fabrics which may be laminated to the multilayered film of this invention desirably have a basis weight between about 10 g/m² and 50 g/m² and even more desirably between about 15 g/m² and 30 g/m². As a particular example, a 17 g/m² (0.5 ounces per square yard) web of polypropylene spunbond fibers can be necked a desired amount and thereafter laminated to a breathable stretched filled-product film 100b. The film 100b would therefore be nipped (in an adhesive nip, or lamination rolls of a calender roll assembly 142) to a necked or CD stretchable spunbond nonwoven web.

The spunbond layer, support layer, or other functional laminate layer may either be provided from a pre-formed roll, or alternatively, be manufactured in-line with the film and brought together shortly after manufacture. For instance, as is illustrated in FIG. 4, one or more spunbond extruders 130 meltspin spunbond fibers 132 onto a forming wire 134 that is part of a continuous belt arrangement. The continuous belt circulates around a series of rollers 136. A vacuum (not shown) may be utilized to maintain the fibers on the forming wire. The fibers may be compressed via compaction rolls 138. Following compaction, the spunbond or other nonwoven material layer is bonded to the multilayered film 100b. As discussed above, such bonding may occur through adhesive bonding, such as through slot or spray adhesive systems, thermal bonding or other bonding means, such as ultrasonic, microwave, extrusion coating and/or compressive force or energy. An adhesive bonding system 140 is illustrated. Such a system may be a spray or a slot coat adhesive system. Examples of suitable adhesives that may be used in the practice of the invention include Rextac 2730, 2723 available from Huntsman Polymers of Houston, Tex., as well as adhesives available from Bostik Findley, Inc, of Wauwatosa, Wis. In an alternative embodiment, the film and nonwoven support layer are laminated with an adhesive such that the basis weight of the adhesive is between about 1.0 and 3.0 gsm. The type and basis weight of the adhesive used will be determined on the elastic attributes desired in the final laminate and end use. In another alternative embodiment, the adhesive is applied directly to the nonwoven support layer prior to lamination with the film. In order to achieve improved drape, the adhesive may be pattern applied to the outer fibrous layer.

The film and support layer material typically enter the lamination rolls 142 at the same rate as the film exits the MDO if present. Alternatively, the film is tensioned or relaxed as it is laminated to the support layer. In an alternative embodiment, bonding agents or tackifiers may be added to the film to improve adhesion of the layers. As previously stated, the filled multilayered film and fibrous layer can be adhesively laminated to one another. By applying the adhesive to the outer fibrous layer, such as a nonwoven fabric, the adhesive will generally only overlie the film at fiber contact points and thus provide a laminate with improved drape and/or breathability. Additional bonding aids or tackifiers can also be used in the fibrous or other outer layer.

After bonding, the laminate 122 may be further processed. Following lamination, the multilayered laminate may be subjected to numerous post-stretching manufacturing processes. In one embodiment of this invention, the laminate 122 may be coursed through a series of grooved rolls 150 that have grooves in the MD direction. The grooved rolls can desirably further orient the skin layers and provide the multilayered film with cross-directional elasticity. Such processing step 150 may also provide additional desired attributes to the laminate 122, such as softness, without sacrificing elasticity or breathability. The grooved rolls 150 may be constructed of steel or other hard material (such as a hard rubber) and may include between about 4 and 15 grooves per inch, desirably between about 6 and 12 grooves per inch, and more desirably between about 8 and 10 grooves per inch. In still a further alternative embodiment grooves on such rolls include valleys of between about 100 thousandths and 25 thousandths of an inch. Following any additional treatment, the laminate may be further slit 160, annealed 114, and/or wound on a winder 112.

The inventive film and/or film laminate may be incorporated into numerous personal care products. For instance, such materials may be particularly advantageous as a stretchable outer cover or side panels for various personal care products. Additionally, such film may be incorporated as a base fabric material in protective garments such as surgical or hospital drapes/gowns. In still a further alternative embodiment, such material may serve as a base fabric for protective recreational covers such as car covers and the like.

The multilayer film of this invention can be used in various absorbent personal care products. The inventive material may be used as a stretchable side panel or ear flap, or an outer cover in a variety of product applications including a training pant, an underwear/underpant, feminine care product, and adult incontinence product. As an side panel or outercover, such material may be present in film form, or alternatively as a laminate in which a nonwoven or other sheet material has been laminated to the film layer.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### Test Method Procedures

Cycle Testing:

The materials were tested using a cyclical testing procedure to determine load loss and percent set. In particular, 2 cycle testing was utilized to 100 percent defined elongation. For this test, the sample size was 3 inch in the MD by 7 inch in the CD. The Grip size was 3 inch width. The grip separation was 4 inch. The samples were loaded such that the cross-direction of the sample was in the vertical direction. A preload of approximately 10-15 grams was set. The test pulled the sample to 100 percent elongation, and then immediately (without pause) returned to the zero. The results of the test data are all from the first and second cycles. The testing was done on a Sintech Corp. constant rate of extension tester 2/S with a Renew MTS mongoose box (controller) using TESTWORKS 4.07b software (Sintech Corp, of Cary, N.C.). The tests were conducted under ambient conditions at a crosshead speed of 20 inches per minute.

Coefficient of Friction(Cof) Test

The COF test was conducted exactly as per the ASTM D 1894-87 and was measured against a metal surface. During the Coefficient of Friction testing, the metal surface used was polished metal 150 by 300 by 1 mm, and the sled used was a metal block (63.5 mm square, 6 mm thick, 199 grams) wrapped in 3.2 mm sponge rubber with a density of 0.25 g/cc.

### EXAMPLES

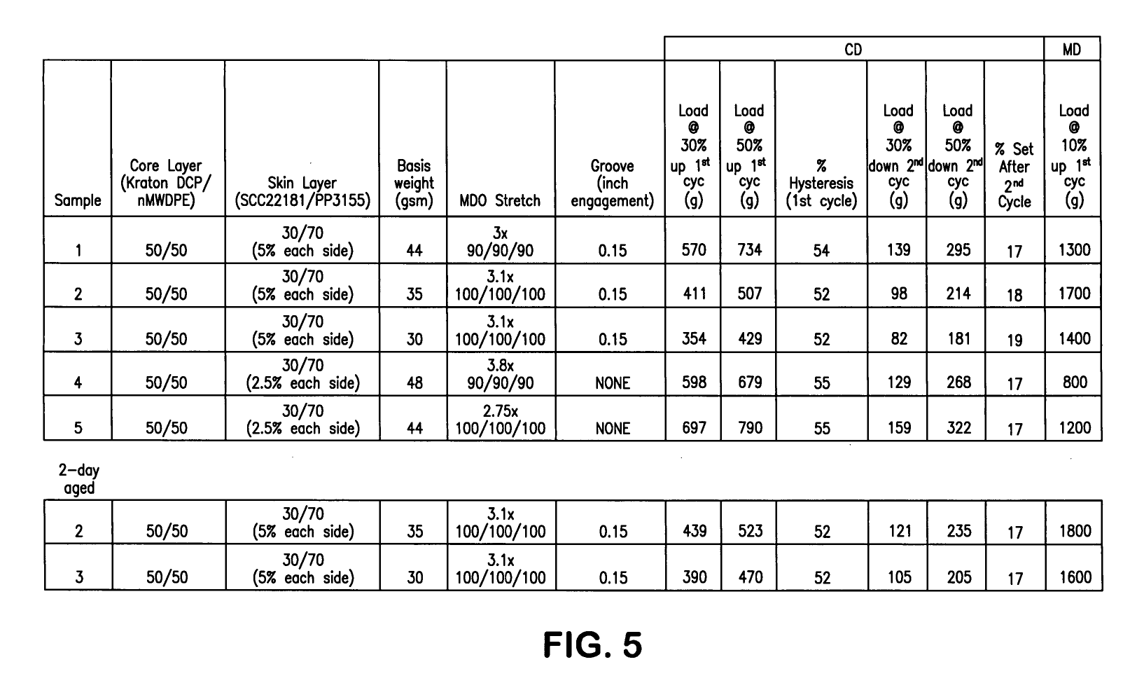

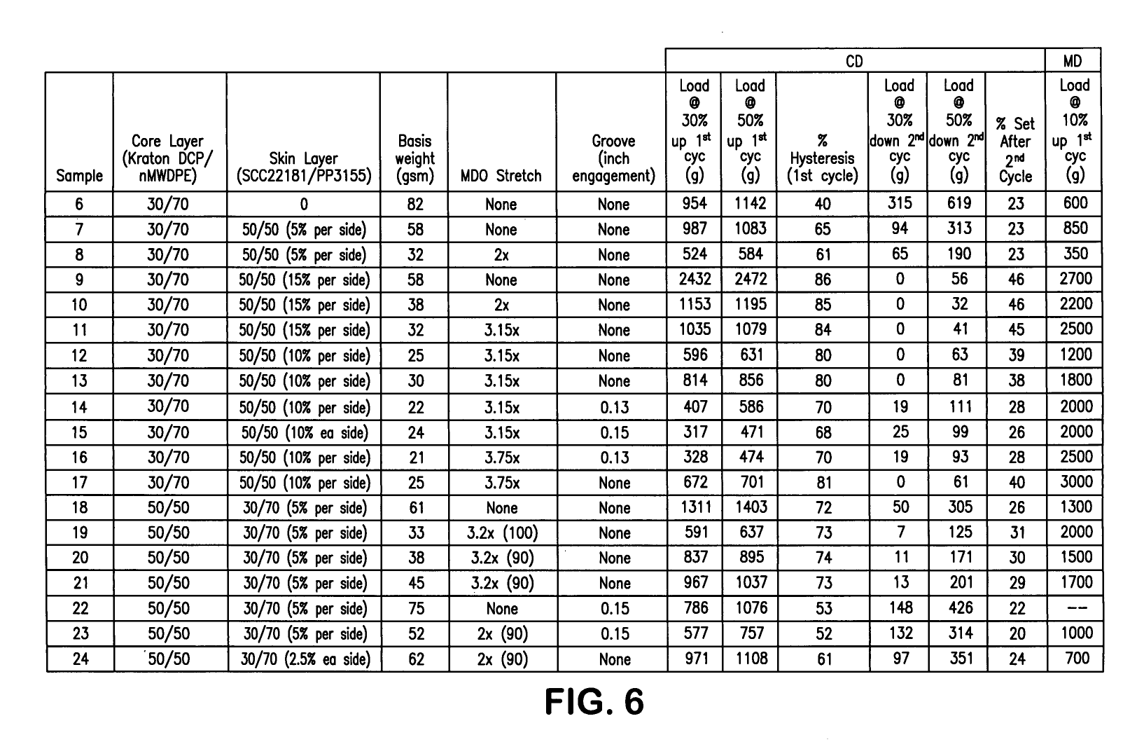

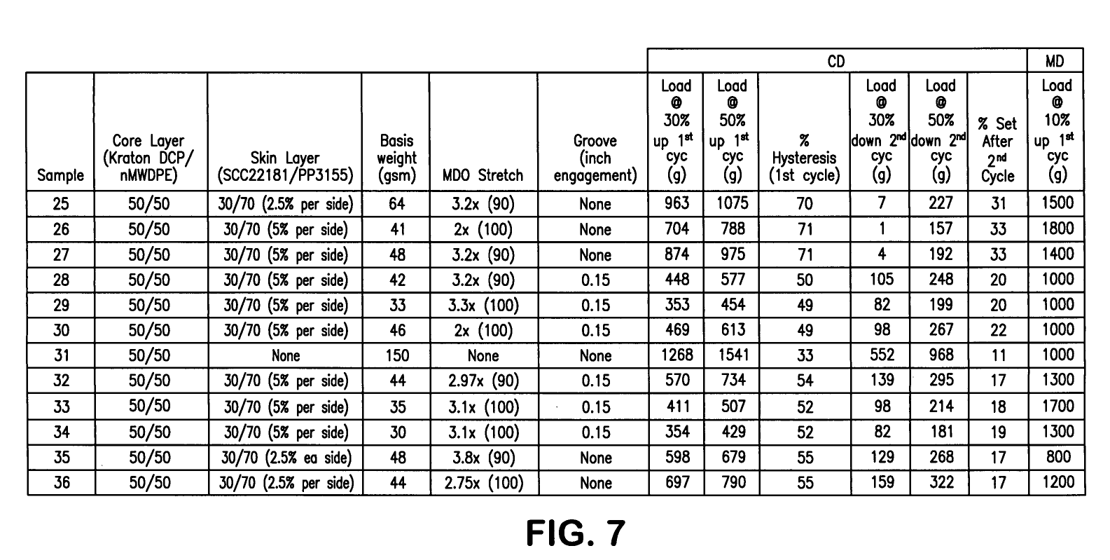

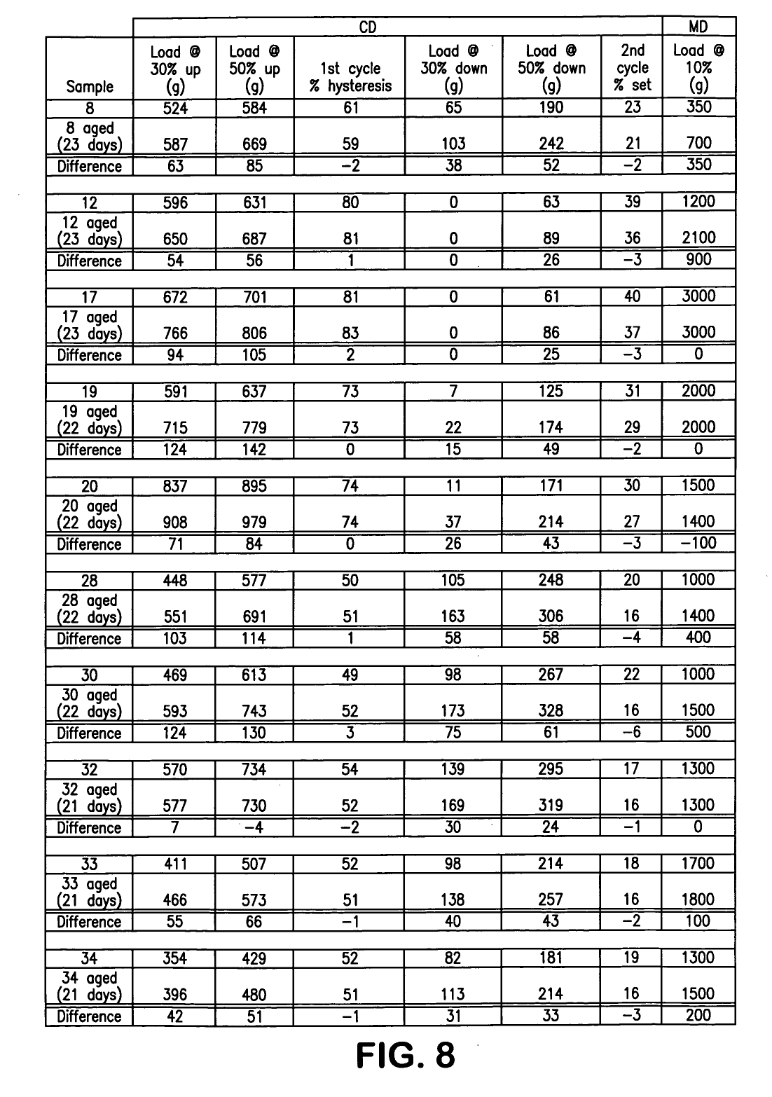

Films were made using KRATON DCP styrenic block copolymer and an experimental, single-cite catalyzed ethylene-octene copolymer from Dow Chemical Co. having a density of 0.87 grams/cm³ and a melt index (190° C.) of 10 grams/10 min, in ratios of 30%/70% and 50%/50% respectively. The skin layers were made of Exxonmobil polypropylene 3155 and a calcium carbonate compound in a blend of polypropylene and polypropylene random copolymers (SCC22181), manufactured by Standridge Color Corporation, Social Circle, Georgia, at ratios of 50%/50% and 75%/25%, respectively. The core layer was not filled and the skin layers included some filler. Skin layer weight percent varied from 2.5% on each side up to 15% on each side. The films were made in the unstretched state and oriented in the machine direction using a MDO up to 3.8× the original length. Grooved samples were grooved to a cross-directional stretch of up to 2.6× without stretching in the MDO and some samples were both MDO stretched and subsequently grooved. The Tables in FIGS. 5-7 summarize the samples and the results. Load measurements were obtained at 30% and 50% up during stretching during a first cycle CD stretching, and 30% and 50% down during retraction after a second cycle CD stretching. Machine-direction load was measured at 10% up during the first cycle stretching. FIG. 8 summarizes the results of particular samples repeated after aging.

The film samples had good CD stretch properties and were significantly stiffer in the machine-direction than films without skin layers and post-processing steps.

The following table provides properties of films made from the skin layer materials used in the Examples.

| | | CD | | MD | | |
|---|---|---|---|---|---|---|
| | Basis | Break | | | Break | |
| | Weight | Elongation | Load @ | Immediate | Elongation | Load @ Break |
| Sample | (gsm) | (%) | Break (g) | Load (g) | (%) | (g) |
| 100% | 19 | 180 | 550 | 700 | 375 | 900 |
| SCC22181 | | | | | | |
| 50% | 21 | 350 | 1400 | 1500 | 400 | 2700 |
| SCC22181/50% | | | | | | |
| PP3155 | | | | | | |
| 100% PP3155 | 20 | 450 | 3000 | 3000 | 400 | 4000 |

To demonstrate non-tacky surface of the multilayered films of this invention, the coefficient of friction of Sample 1 from above was tested. The following comparison films were also tested: 1) a 40% KRATON/60% Dow metallocene polyethylene elastomeric film with no skin layer; 2) a stretched breathable coextruded film including a calcium carbonate filled Septon 2004 SEPS block copolymer with a low density polyethylene skin layer; and 3) a 50 gsm, green colored elastomeric film with skin layers from Nordenia International AG, Germany. The following Table summarizes the results.

| Sample | Peak Load (g) | Static COF | Dynamic COF |
|---|---|---|---|
| Control | 859 | 4.32 | 3.23 |
| Sample 1 | 74 | 0.37 | 0.30 |
| Septon Film | 160 | 0.80 | 0.73 |
| Nordenia Film | 57 | 0.29 | 0.24 |

Thus, the invention provides a multilayered film that has MD stiffness and CD elasticity. Furthermore, the multilayered films of this invention are non-tacky, and can be made breathable by incorporating filler in one or more layers of the film. The multilayered film of this invention provides for more efficient processing when incorporating into personal care products, thereby reducing production time and costs.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A multilayer film, comprising:
an elastomeric polymeric core layer; and
a polymeric skin layer on a side of the core layer, wherein the polymeric skin layer is not elastomeric;
wherein the multilayer film is elastic in a cross-direction.

2. The multilayer film of claim 1, wherein the core layer comprises a thermoplastic elastomer.

3. The multilayer film of claim 1, wherein the core layer comprises a polymer selected from styrenic block copolymers, thermoplastic polyurethanes, single-site catalyzed polyolefins, thermoplastic polyester elastomers, or combinations thereof.

4. The multilayer film of claim 1, wherein the skin layer is extendible in the cross-direction.

5. The multilayer film of claim 1, wherein the skin layer comprises a polyolefin selected from polypropylene, polyethylene, polybutylene, polyester, polystyrene, or combinations thereof.

6. The multilayer film of claim 1, wherein the multilayer film is stable in a machine-direction.

7. The multilayer film of claim 1, wherein the skin layer has a coefficient of friction of about 0.75 or less.

8. The multilayer film of claim 1, wherein the core layer and the skin layer are coextruded.

9. The multilayer film of claim 1, comprising about 2.5% to about 15% by weight of the skin layer.

10. The multilayer film of claim 1, wherein the multilayer film can be stretched by at least about 50% in the cross-direction.

11. The multilayer film of claim 1, wherein the multilayer film can retract at least 50% when stretched to 100% in the cross-direction.

12. The multilayer film of claim 1, wherein the core layer comprises filler particles.

13. The multilayer film of claim 12, wherein the filler particles comprise a material selected from calcium carbonate, non-swellable clay, silica, alumina, barium sulfate, sodium carbonate, talc, magnesium sulfate, titanium dioxide, barium carbonate, kaolin, mica, carbon, calcium oxide, magnesium oxide, aluminum oxide, or combinations thereof.

14. The multilayer film of claim 1, wherein the skin layer comprises filler particles.

15. The multilayer film of claim 14, wherein the filler particles comprise a material selected from calcium carbonate, non-swellable clay, silica, alumina, barium sulfate, sodium carbonate, talc, magnesium sulfate, titanium dioxide, barium carbonate, kaolin, mica, carbon, calcium oxide, magnesium oxide, aluminum oxide, or combinations thereof.

16. The multilayer film of claim 1, wherein both the core layer and the skin layer comprise filler particles.

17. The multilayer film of claim 1, wherein the multilayer film has a water vapor transmission rate of at least about 300 grams/m²-24 hours.

18. The multilayer film of claim 1, wherein the multilayer film has a water vapor transmission rate of about 1000 grams/m²-24 hours to about 5000 grams/m²-24 hours.

19. A breathable multilayer film, comprising:
an elastomeric polymeric core layer;
a polymeric first skin layer on a first side of the core layer, wherein the polymeric first skin layer is not elastomeric; and
a polymeric second skin layer on a second side of the core layer, wherein the polymeric second skin layer is not elastomeric;
wherein the multilayer film is elastic in a cross-direction and has a water vapor transmission rate of at least about 300 grams/m²-24 hours.

20. The multilayer film of claim 19, wherein the core layer comprises a thermoplastic elastomer.

21. The multilayer film of claim 19, wherein the core layer comprises a polymer selected from styrenic block copolymers, thermoplastic polyurethanes, single-site catalyzed polyolefins, thermoplastic polyester elastomers, or combinations thereof.

22. The multilayer film of claim 19, wherein each of the first and second skin layers comprises a polyolefin selected from polypropylene, polyethylene, polybutylene, polyester, polystyrene, or combinations thereof.

23. The multilayer film of claim 19, wherein the multilayer film is stable in a machine-direction.

24. The multilayer film of claim 19, wherein the core layer and the first and second skin layers are coextruded.

25. The multilayer film of claim 19, wherein the first and second skin layers each constitute about 7.5% or less of an overall multilayer film weight.

26. The multilayer film of claim 19, wherein the core layer comprises filler particles.

27. The multilayer film of claim 26, wherein the filler particles comprise a material selected from calcium carbonate, non-swellable clay, silica, alumina, barium sulfate, sodium carbonate, talc, magnesium sulfate, titanium dioxide, barium carbonate, kaolin, mica, carbon, calcium oxide, magnesium oxide, aluminum oxide, or combinations thereof.

28. The multilayer film of claim 26, wherein at least one of the first and second skin layers also comprises the filler particles.

29. A method of producing a multilayer film that is elastic in a cross-direction and inelastic in a machine direction, the method comprising:
extruding an elastomeric polymeric core layer between a first polymeric skin layer and a second polymeric skin layer, wherein the first and second polymeric skin layers are not elastomeric; and
orienting the first and second skin layers to provide the multilayer film with cross-direction elasticity.

30. The method of claim 29, wherein orienting the first and second skin layers comprises stretching the multilayer film in the machine direction.

31. The method of claim 29, wherein orienting the first and second skin layers comprises stretching the multilayer film in the cross-direction.

32. The method of claim 31, wherein stretching the multilayer film in the cross-direction comprises passing the multilayer film through a nip between two grooved rolls.

33. The method of claim 31, wherein stretching the multilayer film in the cross-direction comprises tentering the multilayer film.
